(19) United States
(12) Patent Application Publication
(10) Pub. No.: US 2009/0063828 A1
(43) Pub. Date: Mar. 5, 2009

(54) Systems and Methods for Communication between a PC Application and the DSP in a HDA Audio Codec

(76) Inventors: Daniel L. Chieng, Austin, TX (US); Douglas D. Gephardt, Dripping Springs, TX (US); Larry E. Hand, Meridian, MS (US); Jeffrey M. Klaas, Lakeway, TX (US); Adam Zaharias, Austin, TX (US)

Correspondence Address: LAW OFFICES OF MARK L. BERRIER, 3811 BEE CAVES ROAD, SUITE 204, AUSTIN, TX, 78746, US

(21) Appl. No.: 12/202,356

(22) Filed: Sep. 1, 2008

Related U.S. Application Data
(60) Provisional application No. 60/969,609, filed on Sep. 1, 2007.

(51) Int. Cl. G06F 9/315

(52) U.S. Cl. 712/225; 712/E09.034

(57) ABSTRACT

Systems and methods implemented in a PC for enabling communication between an application executing on the CPU and a DSP that is incorporated into a codec in the High Definition Audio (HDA) system, wherein the communication is carried out via the HDA bus. In one embodiment, an HDA codec includes one or more conventional HDA widgets coupled to a programmable processor such as a DSP. The codec includes a set of registers that are configured to store HDA verbs and data transmitted via the HDA bus. The programmable processor is configured to identify verbs that indicate associated information is a communication from an application executing on the CPU, read the associated information, and process the information according to the associated verbs. The information may be program instructions, parametric data, requests for information, etc.

### CROSS-REFERENCE TO RELATED APPLICATIONS

This application claims the benefit of U.S. Provisional Patent Application 60/969,609, filed Sep. 1, 2007, which is hereby incorporated by reference as if set forth herein in its entirety.

### BRIEF DESCRIPTION OF THE DRAWINGS

Other objects and advantages of the invention may become apparent upon reading the following detailed description and upon reference to the accompanying drawings.

FIG. 1 is a functional block diagram illustrating the hardware structure of a system having a High Definition Audio (HDA) architecture that incorporates processor-based codecs in accordance with one embodiment.

FIG. 2 is a diagram illustrating the interconnection of widgets in an exemplary HDA codec with an integrated pulse width modulation (PWM) controller/amplifier in accordance with one embodiment.

FIG. 3 is a diagram illustrating the communication link between the CPU of a PC a DSP in a codec using the HDA bus coupled between them in accordance with one embodiment.

FIG. 4 is a flow diagram illustrating a procedure for transmission of a 24-bit word from the application to the DSP in accordance with one embodiment.

FIG. 5 is a flow diagram illustrating a procedure for the application requesting that the DSP provide a setting for a particular parameter in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods implemented in a personal computer (PC) having a High Definition Audio (HDA) system. The present systems and methods enable communication between an application executing on the PC's central processing unit (CPU) and a digital signal processor (DSP) that is incorporated into a codec in the HDA system, wherein the communication is carried out via the HDA bus.

In one embodiment, an HDA codec includes one or more conventional HDA widgets coupled to a programmable processor such as a DSP. The codec includes a set of registers that are configured to store HDA verbs and data transmitted via the HDA bus. The programmable processor is configured to identify verbs that indicate associated information is a communication from an application executing on a CPU external to the codec, read the associated information, and process the information according to the associated verbs. The information may be of various types, such as program instructions, parametric data, requests for information, etc. In one embodiment, the registers include HDA general purpose registers for an input byte, an output byte, and a control/status byte. These HDA registers are coupled between the codec's HDA interface and a set of DSP-accessible registers that store three input bytes, three output bytes and a control/status byte. The registers are used to convert data from one byte wide at the HDA interface to three bytes wide at the DSP.

An alternative embodiment may include PC systems that enable communications over an HDA bus between applications executing on the PC's CPU and the DSP of an HDA codec. Another alternative embodiment may include a method for communicating over an HDA bus between applications executing on a CPU and the DSP in an HDA codec.

PC-Based Audio

With the proliferation of PCs and advances in computer technologies, there has been a demand for PCs that have an increasing number of advanced features. Customers that purchase multimedia PCs and high-end gaming PCs in particular are demanding premium audio quality in order to achieve the ultimate audio/visual experience from their PCs. This demand has been addressed to some extent by the High Definition Audio specification introduced by Intel.

When Intel's 1997 Audio Codec standard (AC'97) was introduced, PC users typically listened to music and movies that only had stereo sound. As multi-channel audio formats such as Dolby Digital and DTS became more popular, users became accustomed to these audio formats and began to expect full surround, multi-speaker sound using these formats to be available in a PC environment. While AC'97 technology was initially adequate, it has not been able to keep pace with more recent advancements (e.g., newer audio and video encoding/decoding algorithms) that enable the PC to produce higher-quality audio.

Beginning with the introduction of Intel's High Definition Audio Specification Rev 1.0 in 2004, which is incorporated herein by reference, the HDA interface has been gradually gaining popularity in the PC space. The HDA architecture defined by the Intel specification attempts to meet the need for high quality audio in the PC space. This architecture defines the delivery of high fidelity audio content from a PC's memory to one or more audio codecs using an HDA controller that performs direct memory access (DMA) transfers of audio data over an HDA bus. The audio data delivered over the HDA bus is received, processed and output by the various components of the codecs (referred to in the HDA specification as “widgets.”)

While the HDA specification allows quite a bit of flexibility in the design of an HDA system for a PC, this flexibility is lost when the design is implemented. For instance, while an HDA system may have multiple codecs that perform different types of processing on audio data, these codecs are hardwired and their functionality cannot be changed. It would be desirable to provide systems and methods that maintain the flexibility of the HDA system, including enabling changes to the functionality of the system after it is implemented.

This flexibility is provided in one system by providing an HDA codec that incorporates a DSP. The DSP is programmable so that the functionality of the codec can be modified by changing the programming of the DSP. The programming of a DSP is conventionally accomplished by connected a programming device directly to the DSP via an interconnect (e.g., I2C, SPI, or USB) and transferring program instructions and configuration information to the DSP. In the present systems and methods, however, it is desirable to eliminate the need for this separate interconnect, so the communication of the program and configuration information is transferred to the DSP via the HDA bus.

High Definition Audio (HDA)

With the introduction of Intel's High Definition Audio Specification Rev 1.0 in 2004, the HDA interface has been gradually gaining popularity in the PC space. Users of multimedia PCs and high-end gaming PCs in particular are demanding premium audio quality in order to achieve the ultimate audio/visual experience from their PCs. The HDA architecture bridges the gap in delivering high fidelity audio content from the memory system of the PC to the audio codecs of the HDA system.

The primary goal of the HDA specification is to describe an infrastructure within a PC environment which is designed to support high quality audio. This infrastructure provides a mechanism for transferring audio data directly from the PC's memory system to one or more audio codecs via an HDA bus. The codecs typically convert the digital audio data received from the memory to analog signals and process these signals to output signals that can be provided as, for instance, a line output, a modem output, or an output to an amplifier.

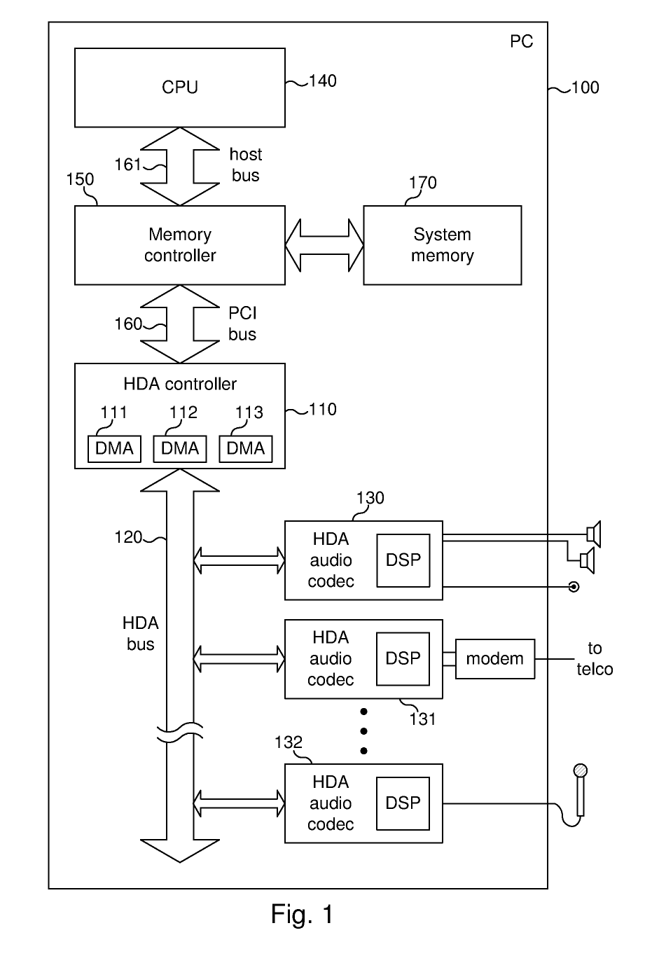

Referring to FIG. 1, a functional block diagram illustrating the hardware structure of a system having an HDA architecture that incorporates DSP-based codecs is shown. As depicted in this figure, the HDA architecture in a PC 100 includes an HDA controller 110, an HDA bus 120 and several codecs 130-132. (While FIG. 1 includes three codecs, there may be more or fewer codecs in a given embodiment.) These components are constructed on the motherboard of the PC, along with CPU 140 and memory controller 150.

HDA controller 110 is coupled to memory controller 150 via a bus (160) such as a PCI bus or other type of system bus. Memory controller 150 is coupled to CPU 140 by a host bus 161. Memory controller 150 is also coupled to the system memory 170. Codecs 130-132 may be connected to one or more converters in order to convert the audio data processed by the codecs to a suitable output format, or to convert input data received by the codecs to appropriate formats for use by the codecs. The audio processing of the codecs is performed by a combination of conventional widgets and a programmable processor such as a DSP. The output signals produced by the converters may be provided to a variety of output devices such as amplifiers, speakers or headphones.

HDA controller 110 acts as a bus mastering input/output (I/O) device on the PCI bus. HDA controller 110 includes multiple DMA engines 111-113. (Although three DMA engines are depicted in the figure, there may be more or fewer in a given embodiment.) DMA engines 111-113 control the transfer of data between system memory 170 (via memory controller 150 and bus 160) and the various HDA codecs 130-132. The DMA engines can transfer data from the codecs to the system memory, as well as transferring data from the system memory to the codecs.

HDA bus 120 is configured to support serial data transfers between HDA controller 110 and codecs 130-132. HDA bus 120 is also used to distribute a 24 MHz bit line clock from HDA controller 110 to codecs 130-132. This bit line clock is used by the controller and the codecs to enable the transfer of data over the HDA bus. The codecs use the bit line clock to extract time-multiplexed, serialized data from the HDA bus.

Typically, each of codecs 130-132 will extract a stream of digital data from the time-multiplexed data on HDA bus 120. This digital data will be converted to an analog signal and processed by the codec. The processing may include performing a variety of functions, such as volume control, muting, mixing, and the like. As noted above, the processed data may be provided to a converter which can convert the processed signal if necessary to produce an output signal (e.g., the converter may convert the analog signal into a digital output signal). In addition to processing audio data, codecs 130-132 may provide control data to HDA controller 110 via HDA bus 120. The codecs may also receive input signals (e.g., an analog input signal from a microphone), process the signals, and provide these signals to the HDA controller via the HDA bus.

Data is transferred between system memory 170 and codecs 130-132 in “streams.” In the HDA specification, a stream is a logical connection between one of the codecs and a buffer in the system memory. Each stream is driven by a corresponding one of the DMA engines in the HDA controller. The DMA engine can only drive a single stream, so if the system has more streams than DMA engines, one or more of the streams must remain inactive until DMA engines become available to drive them. A stream may be either an input stream or an output stream, but not both. Output streams are considered broadcast streams, and may be received by more than one of the codecs. Input streams, on the other hand, are associated with only a single one of the codecs.

As noted above, the streams are conveyed over the HDA bus as time-multiplexed data. The HDA bus transmits a serial bit stream of data formatted in successive frames. The frame rate is 48 kHz, so each frame is 20.83 microseconds long. The frame can be broken down into fields, including a field for command and/or response data, as well as sample fields for each of the one or more streams. The frame may also include null space if less than the maximum number of streams is being transmitted. Within each sample in a stream of data, there are typically fields for data corresponding to two channels (e.g., left and right stereo channels). It should be noted, however, that more channels (e.g., left, right, left rear and right rear) can be transmitted. Also, multiple sample fields can be used to convey data for a single channel that has a data rate greater than the 48 kHz frame rate.

The HDA specification is intended to define an architecture in which codecs have a modular construction. The codecs make use of parametrized building blocks (widgets) to form a codec that is discoverable and configurable. The widgets, and collections of widgets, are uniquely addressable nodes in the HDA architecture. As a result, a software driver can identify and control the various operations of the codecs.

The widgets that form an HDA codec are interconnected to form function groups within the codecs. A codec can contain more than one function group. A codec may, for example, contain several audio function groups that process audio data for different audio channels. Widgets that are commonly used in these audio function groups include audio output converter widgets, audio input converter widgets, I/O (pin) widgets, mixer widgets, selector (mux) widgets, power state widgets, and volume widgets.

HDA Codec Having an Integral Processor

Conventionally, the widgets in a codec are hardwired together. A particular codec may be designed to perform a number of functions, but these functions are performed by widgets that have fixed functions, so the functions of the codec are also fixed once its design has been established and the codec constructed. The present codec, on the other hand, incorporates a programmable processor such as a DSP.

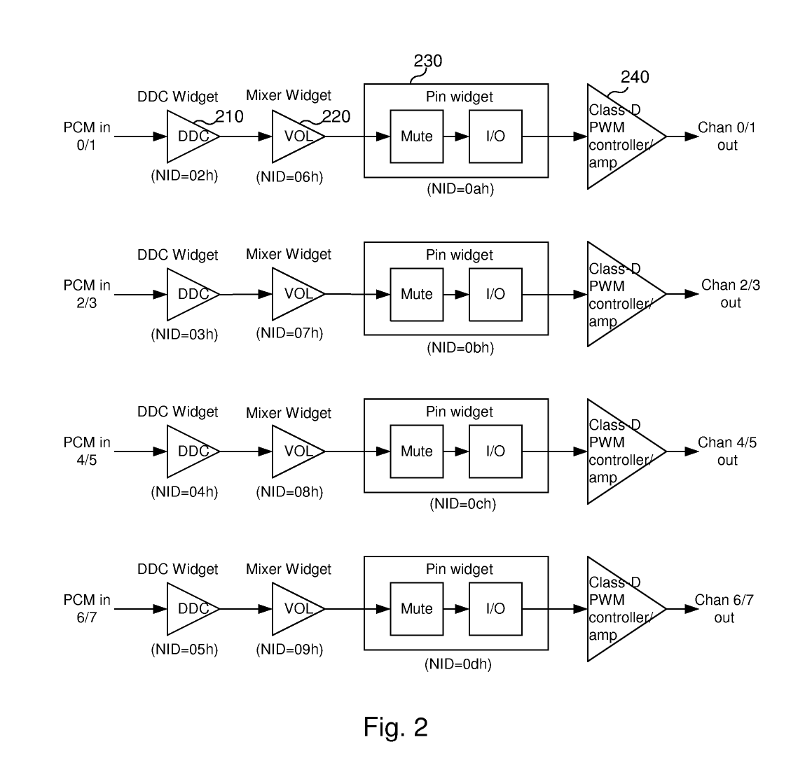

The DSP provides the capability to perform intelligent processing of audio data. In one embodiment, the DSP is programmed to function as a Class-D PWM controller that is integrated into an HDA codec. Referring to FIG. 2, a diagram illustrating the interconnection of widgets in an exemplary HDA codec with an integrated PWM controller/amplifier is shown. In this example, the codec is configured to process eight channels (four stereo pairs) of audio data. Each stereo pair is converted from an input digital format to an internal digital format by a DDC widget (e.g., 210). Because the stream(s) of data on the HDA bus are time-multiplexed, the DDC widget pulls the appropriate packets of audio data from the bus and formats the data into a digital stream (e.g., an I2S data stream) that can be processed in the codec. (In this embodiment, the codec processes the signal in a digital, rather than analog, form.) The digital signal is then processed by a mixer widget (e.g., 220), which may sum the signal with other signals or control the volume of the signal, and a pin widget (e.g., 230), which can mute the signal and output the signal to a PWM controller/amplifier (e.g., 240).

It should be noted that the mixer widget and pin widget may be virtual (or logical) components of the codec. While the DDC widget is a hardware component that is necessary to pull data off the HDA bus, the mixer and pin widgets usually perform functions that can be provided by the DSP. Consequently, the mixer and pin widgets may be present as hardware (which need not be used) or the DSP may simply represent these widgets logically, so that commands addressed to these widgets are forwarded to the DSP, where they are processed in the same manner as if the widgets had been physically present. For instance, where the mixer widget would normally control the volume of the audio signal processed by the codec, the DSP can control the volume as a function of the PWM controller. Similarly, where the pin widget would normally control muting and input/output functions, these functions can be implemented in the PWM controller.

An all digital Class-D PWM controller is superior to its analog counter-part because of the inclusion of a DSP. The DSP allows customization of audio sound such as parametric equalization, psycho-acoustic effects, room equalization, virtual surround sound, bass boost, mixing, custom filters, and so on. These features are usually accessible through dedicated control ports such as I2C, SPI, or USB, which in a typical standalone system are cost effective ways to communicate with the DSP. In a PC system, however, cost pressure is high and eliminating a dedicated hardware connection is valuable because of the resulting cost reduction. The present systems therefore enable communication between an application executing on the PC and the DSP via the HDA bus in order to enable programming and configuration of the DSP without the need for a dedicated hardware connection.

Communicating with the Codec's Processor Via the HDA Bus

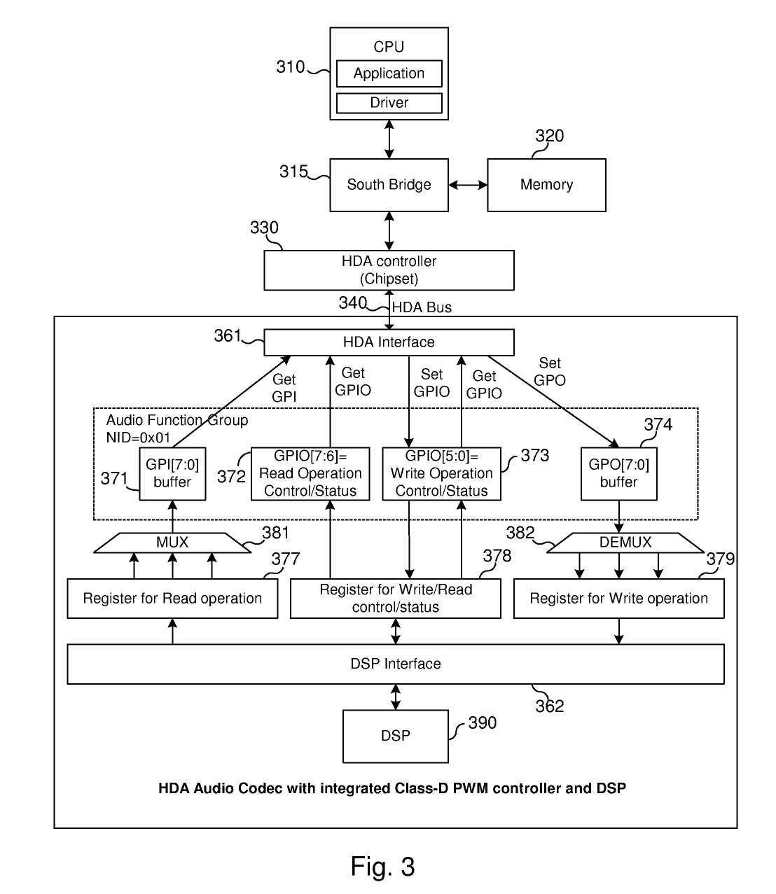

In order for the DSP to perform audio signal processing, the DSP must be able to communicate with the PC application to transmit and receive information such as parameters, settings, status, etc. Referring to FIG. 3, a diagram illustrating the communication link between the application executing on the PC's CPU and the DSP is shown.

In the embodiment of FIG. 3, CPU 310 and memory 320 are connected to South Bridge 315, which is in turn connected to HDA controller 330. HDA controller 330 and HDA codec 350 are both connected to HDA bus 340. Codec 350 has an HDA interface 361 which is connected to HDA bus 340. Registers GPI (371), GPIO (372-373) and GPO (374) are connected to HDA interface 361 and are configured to store I/O data that is transferred over HDA bus 340. (Read and write portions of the GPIO register are shown as separate blocks 372 and 373 in the figure.) Multiplexer 381 is connected to GPI register 371 and serves to select one of three bytes stored in DSP read register 377 to store in GPI register 371. Multiplexer 382 is connected to GPO register 374 and serves to store the byte of data from GPO register 374 in a selected one of the three byte locations in DSP write register 379. DSP control/status register 378 is connected to GPIO register 372-373. DSP interface 362 couples DSP 390 to registers 377-379.

CPU 310 executes a corresponding software application and driver. The application controls communications with the DSP and causes the driver to drive data to the HDA controller. The HDA controller then drives this data onto the HDA bus. The HDA interface of the codec then reads the data off the HDA bus and forwards the data to the appropriate nodes in the codec function group so that it can be passed to the appropriate registers. From the registers, the data is passed through the DSP interface to the DSP, which can then respond to the data (e.g., by updating its programming, modifying its response, returning control information, etc.). The DSP returns data to the application by the reverse of this process. It should be noted that the DSP does not put verbs on the HDA bus, but instead puts data on the bus which is responsive to verbs (e.g., get control/status information, read data, etc.) that are put on the bus by the application.

As noted above, data is communicated over the HDA bus in frames. The frame rate of this data is 48 kHz. Each frame includes a command/response field and one or more packets of data. Each of the packets corresponds to a stream to or from one of the codecs. The command/response field in each frame is used to communicate information to or from the codecs.

The command/response field in each outbound frame consists of 40 bits. This field includes 8 reserved bits (transmitted as 0's), a 4-bit codec identifier, an 8-bit bit node identifier to identify a target node within the codec, and a 20-bit verb. The command/response field of each inbound frame consists of 36 bits. This includes a valid bit, an “unsolicited” bit, 2 reserved bits (transmitted as 0's), and a 32-bit response.

To enable communication of parameters, settings, status, etc. between the DSP and the PC application, the present system utilizes a set of HDA specified verbs to create a virtual communication channel between the application and the DSP inside the HDA audio codec. These verbs are listed in Table 1 below.

TABLE 1
verbs

| Verb | Verb ID | Purpose |
|---|---|---|
| Set GPIO | 0x715 | Set control |
| Get GPIO | 0xF15 | Get Control/status |
| Set GPO | 0x714 | Send/Write data |
| Get GPI | 0xF10 | Receive/Read data |

The 8-bit GPIO is designated as control/status. GPO is data sent from the application to the DSP in write operations, and GPI is data received by the application from the DSP in read operations. GPIO control/status is further split between the read and write operations as defined in Table 2. For read operations, the GPIO control/status is referred to as gpiCntl, and for write operations, it is referred to as gpoCntl.

TABLE 2
GPIO control/status definition

| GPIO | Register | Bit field | |
|---|---|---|---|
| bits | name | name | Description |
| [7:6] | gpiCntl[1:0] | GPIPOS | GPI buffer status |
| [5] | gpoCntl[5] | — | Reserved |
| [4] | gpoCntl[4] | — | Reserved |
| [3] | gpoCntl[3] | GPOWR | Write or Read |
| [2] | gpoCntl[2] | STPKT | Start packet |
| [1:0] | gpoCntl[1:0] | GPOPOS | GPO buffer |
| | | | control/status |

GPOPOS indicates the GPO/write buffer byte position when the DSP operates on words (which, in one embodiment, are 24-bit words). It can also reset the buffer and can indicate whether the GPO buffer is “empty” (i.e., whether data has been read by the DSP). STPKT is a control bit for packet start, and GPOWR is a control bit to indicate that the communication transaction is a write or read operation. STPKT can be used for sending a large packet over the bus. A write operation does not cause data to be returned by the DSP, but a read operation does. GPIPOS indicates the GPI/read buffer byte position when the DSP operates on words, and is also used to indicate buffer “full” status.

The HDA interface exposes a set of GPIO pin widgets that are 1 byte wide that can be read or written. A general purpose input output (GPIO) register is used to store the status of incoming and outgoing data, as well as the reset states of the DSP logic. There are two different resets available in the GPIO register. One is the boot-over-HDA reset that causes the DSP boot loader to look for the program to come from the HDA link. The other reset is the boot-normal reset that causes the DSP boot loader to look for the program to come from the HDA bus or elsewhere, depending on what the boot mode pins are set to. The general purpose input (GPI) register is used to store words that came from the HDA link, and the general purpose output (GPO) register is used to store words that are sent over the link.

In this embodiment, the DSP's memory space is three bytes wide. The HDA link, on the other hand, is one byte wide. To overcome the difference in word alignment, the DSP uses a counter to keep track of which byte was sent or received across the HDA bus. The status of which byte is being sent/received on the bus is available in the GPIO register. The HDA bus sees the widget as only a byte-wide register. On the DSP side, the DSP sees the widget as a three-byte register that has a status value in the GPIO register indicating which byte is being conveyed on the HDA bus.

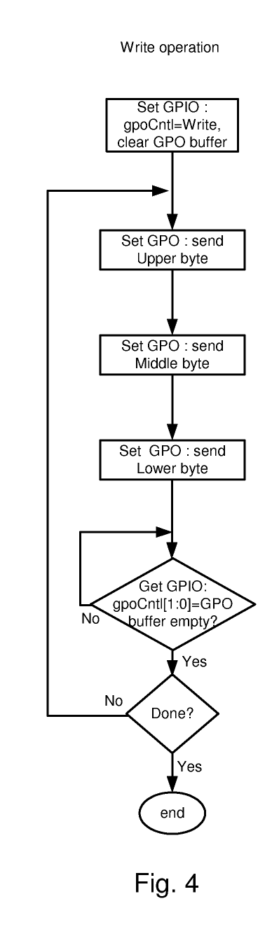

A write operation in this system involves a series of SET-GPIO, SET-GPO, and GET-GPIO verbs. Using this operation, the application sends parametric settings, controls, coefficients, data, etc. to the DSP. Referring to FIG. 4, a flow diagram illustrating the transmission of a 24-bit word from the application to the DSP is shown. First, the Verb ID 0x715 and GPIO[5:0]=0x00 are put on the HDA bus by the application. This begins the write operation by clearing the GPO buffer and indicating write operation. Then, Verb ID 0x714 is put on the bus with GPO set to the upper byte of the 24-bit word. This sends the upper byte of the 24-bit word. The DSP identifies and reads the byte of the GPO. Next, Verb ID 0x714 is again put on the bus, but with GPO set to the middle byte of the 24-bit word. The DSP again reads the byte of the GPO as the middle byte of the word. Finally, Verb ID 0x714 is put on the bus with GPO set to the lower byte of the 24-bit word. The DSP then reads this byte to complete transmission of the 24-bit word. This procedure is repeated for successive words that need to be transmitted from the application to the DSP.

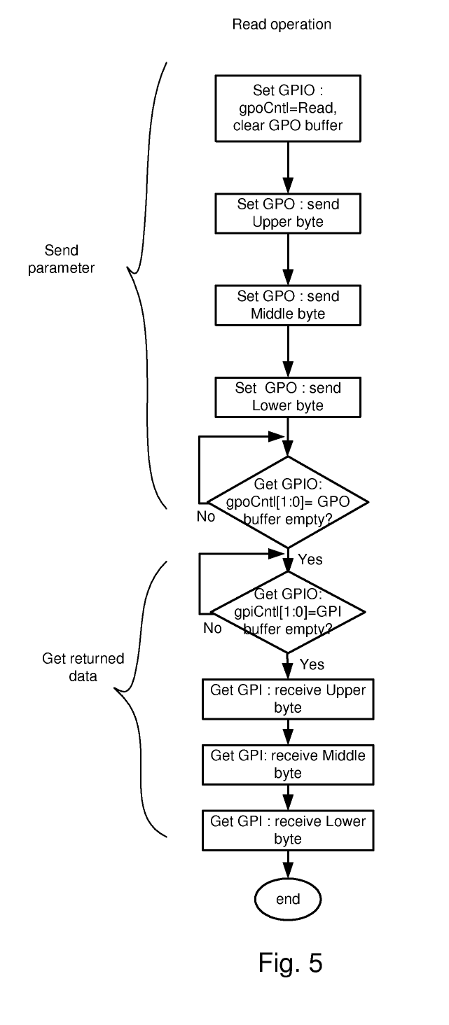

A read operation usually involves doing a write first and then the read. The write operation is to tell the DSP what information/status it is inquiring. For example, the application may need to know the settings of a particular parameter, so it will transfer an identifier of the parameter to the DSP, then request a response from the DSP, and then the DSP will transfer the parameter value back to the application. An example of this procedure is illustrated in FIG. 5.

Referring to FIG. 5, a flow diagram illustrating a procedure for the application requesting that the DSP provide a setting for a particular parameter is shown. The application first sends Verb ID 0x715 on the HDA bus with GPIO[5:0] set to 0x00 . This begins the write portion of the operation by clearing the GPO buffer and indicating the write operation. On the next frame, the application sends Verb ID 0x714 with GPO set to the upper byte of the word identifying the requested parameter. The DSP reads this byte from the bus. On the next frame, the application sends Verb ID 0x714 with GPO set to the middle byte of the word identifying the parameter, which is then read by the DSP. On the next frame, the application sends Verb ID 0x714 with GPO set to the lower byte of the parameter identifier, which is then read by the DSP to complete the first portion of the procedure.

The application then sends Verb ID 0xF15 on the next frame to begin the read portion of the operation (in which the DSP writes data to the HDA bus and the application reads the data from the bus). After sending Verb ID 0xF15, the application waits for the GPI buffer to be full. In other words, the application waits for gpiCntl[1:0] (GPIO[7:6]) to be 0x1, indicating that the buffer is full. If the value in this field is not 0x1, the step of sending Verb ID 0xF15 is repeated. When the DSP has loaded its response into the GPI buffer, it sets the value of gpiCntl[1:0] to 0x1. The application then sends Verb ID 0xF10 and reads the upper byte of the 24-bit setting from the GPI buffer. The DSP then loads the middle byte of the response into the buffer, and the applications sends Verb ID 0xF10 and reads this middle byte from the GPI buffer. Finally, the DSP loads the lower byte of the response into the buffer and the application sends Verb ID 0xF10 and reads the lower byte. When the application reads the lower byte from the GPI buffer, the procedure is complete.

While the foregoing example describes an inquiry by the application and a response by the DSP, the communication mechanism of the present system can be used for many other purposes. For instance, the application may transmit program instructions to the DSP, and the DSP may update its programming and execute these instructions. The application may alternatively transmit parametric data to the DSP. This parametric data may include audio equalization information, filter coefficients, or other data that affects the response of the codec as it processes audio data. In another example, the application may transmit information to the DSP to customize the response of the PWM controller/amplifier. The DSP may further be configured to transmit information defining the customization back to the application so that the customization can be stored in the PC's system memory.

It should be noted that the terms “PC” and “personal computer” are used herein to refer to a wide range of computing systems that are commonly purchased and used by individual consumers. These systems may include desktop computers, laptop computers, tablet computers and the like, and may be used in home, office, mobile or other environments. It should also be noted that, although the embodiments described above focus on codecs that incorporate DSP's, other embodiments may use types of processors other than DSP's (such as general purpose programmable processors, programmable microcontrollers, etc.) to achieve the programmability, configurability and other advantages that are obtained through the use of a processor in the HDA codec.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. An HDA codec comprising:
a programmable processor; and
one or more registers configured to store HDA verbs and data transmitted via the HDA bus;
wherein the programmable processor is configured to identify one or more verbs that indicate associated data comprises a communication from an application executing on a CPU external to the codec, to retrieve the associated data, and to process the data according to the one or more verbs associated with the data.

2. The HDA codec of claim 1, wherein the programmable processor comprises a digital signal processor (DSP).

3. The HDA codec of claim 2, wherein the DSP is configured as a Class-D PWM controller.

4. The HDA codec of claim 3, wherein the DSP is configured to modify the response of the Class-D PWM controller based on the received communication.

5. The HDA codec of claim 2, further comprising a set of HDA input/output (GPIO) registers configured to temporarily store data that is communicated between the application and the programmable processor.

6. The HDA codec of claim 5, further comprising a set of DSP-accessible registers coupled to the GPIO registers and configured to temporarily store data that is communicated between the application and the programmable processor, wherein each of the GPIO registers is no more than one byte wide, and wherein the set of DSP-accessible registers is at least two bytes wide.

7. The HDA codec of claim 1, wherein the programmable processor is configured to provide data responsive to the received communication.

8. The HDA codec of claim 1, wherein the programmable processor is configured to modify operation of the programmable processor based on the data.

9. The HDA codec of claim 8, wherein the data comprises one or more program instructions and the processor is configured to execute the program instructions.

10. The HDA codec of claim 1, further comprising one or more HDA widgets coupled to the programmable processor.

11. A method implemented in a PC, the method comprising:
defining one or more HDA verbs to indicate communications between an application executing on a CPU of a PC and a programmable processor in an HDA codec in the PC; and
transmitting one of the one or more HDA verbs and associated data on an HDA bus that is coupled between the CPU and the codec.

12. The method of claim 11, further comprising modifying operation of the programmable processor based on the transmitted one of the one or more HDA verbs and associated data.

13. The method of claim 12, wherein modifying operation of the programmable processor comprises modifying a program executing on the programmable processor.

14. The method of claim 11, wherein transmitting one of the one or more HDA verbs and associated data on the HDA bus comprises the application putting a request for data on the HDA bus in one or more successive frames and the programmable processor putting responsive data on the HDA bus in one or more subsequent frames.

15. The method of claim 11, wherein transmitting one of the one or more HDA verbs and associated data on the HDA bus comprises:
(a) the application putting a first verb on the HDA bus to clear a GPO buffer and indicate a write operation;
(b) the application sending a second verb with a GPO field set to a first byte of a word identifying requested data;
(c) the programmable processor reading the first byte from the bus;
(d) repeating (b) and (c) for any additional bytes of the word identifying the requested data;
(e) the application sending a third verb to indicate the end of the write operation;
(f) the application waiting for the programmable processor to indicate that a GPI buffer is full;
(g) the programmable processor putting responsive data in the GPI buffer and indicating that the GPI buffer is full;
(h) the application sending a fourth verb and reading a first byte of the responsive data; and
(i) repeating (h) for any additional bytes of the responsive data.

16. An audio amplification system comprising:
a CPU configured to execute an application;
an HDA bus coupled to the CPU; and
an HDA codec coupled to the HDA bus, wherein the codec incorporates a programmable processor;
wherein the application executing on the CPU communicates with the programmable processor via the HDA bus.

17. The audio amplification system of claim 16, wherein the application is configured to communicate program instructions to the programmable processor via the HDA bus.

18. The audio amplification system of claim 16, wherein the application is configured to communicate parametric data to the programmable processor via the HDA bus.

19. The audio amplification system of claim 16, wherein the application is configured to communicate data that is multiple bytes wide to the programmable processor via the HDA bus.

20. The audio amplification system of claim 19, wherein the data is communicated over multiple HDA bus frames.

21. The audio amplification system of claim 16, further comprising an HDA controller coupled between the CPU and the HDA bus, wherein the application includes a driver configured to cause the HDA controller to convey information between the application and the programmable processor via the HDA bus.

22. The audio amplification system of claim 16, wherein the application is configured to convey HDA verbs on the HDA bus, wherein a first set of the verbs and associated data comprise communications between the application and the programmable processor, and wherein the programmable processor is configured to identify verbs in the first set and to respond to the communications of the verbs in the first set.

23. The audio amplification system of claim 22, wherein the verbs in the first set include verbs which set control data for the programmable processor, get control data from the programmable processor, send data to the programmable processor, and receive data from the programmable processor.

24. The audio amplification system of claim 16, wherein the programmable processor comprises a digital signal processor (DSP).

25. The audio amplification system of claim 16, wherein the programmable processor is configured as a Class-D PWM controller.
